(19) United States
(12) Patent Application Publication
(10) Pub. No.: US 2003/0115316 A1
(43) Pub. Date: Jun. 19, 2003

(54) System and method for network usage metering

(76) Inventor: Siew-Hong Yang-Huffman, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/012,720

(22) Filed: Dec. 7, 2001

(51) Int. Cl. G06F 15/173; G06F 15/16

(52) U.S. Cl. 709/224; 709/223; 709/217

(57) ABSTRACT

The present invention is directed to a system and method for metering Internet usage, including monitoring Internet usage by a customer, logging data processing resource consumption by the monitored Internet usage, and determining a quantity of data processing resource consumption logged within a defined time period by the customer. It will be appreciated that network usage by more than one customer at a time may be logged and tabulated by the system and method of the present invention.

### RELATED APPLICATIONS

The instant application is related to co-pending, concurrently filed, and commonly assigned patent application, application Ser. No. [Attorney Docket No. 10012517], entitled “ENHANCED SYSTEM AND METHOD FOR NETWORK USAGE MONITORING” the disclosure of which application is hereby incorporated herein by reference. This patent application is also related to the following co-pending and commonly assigned U.S. patent applications: Ser. No. 09/559,438 entitled “INTERNET USAGE DATA RECORDING SYSTEM AND METHOD EMPLOYING BATCH CORRELATION OF INDEPENDENT DATA SOURCES”; Ser. No. 09/560,509 entitled “INTERNET USAGE DATA RECORDING SYSTEM AND METHOD WITH CONFIGURABLE DATA COLLECTOR SYSTEM”; Ser. No. 09/559,693, entitled “INTERNET USAGE DATA RECORDING SYSTEM AND METHOD EMPLOYING DISTRIBUTED DATA PROCESSING AND DATA STORAGE”; and Ser. No. 09/560,032, entitled “INTERNET USAGE DATA RECORDING SYSTEM AND METHOD EMPLOYING A CONFIGURABLE RULE ENGINE FOR THE PROCESSING AND CORRELATION OF NETWORK DATA”, which were all filed on Apr. 27, 2000, and are all hereby incorporated herein by reference. The application is further related to the following co-pending and commonly assigned U.S. patent application, Ser. No. [Attorney Docket No. 10002144] entitled “INTERNET USAGE DATA RECORDING SYSTEM AND METHOD EMPLOYING A CONFIGURABLE RULE ENGINE WITH IP ADDRESS RANGE MATCHING FOR THE PROCESSING OF NETWORK DATA”, the disclosure of which is hereby incorporated herein by reference.

### TECHNICAL FIELD

The present invention relates in general to network management and in particular to metering Internet usage.

### BACKGROUND

The increasing use of services over the Internet and the increasing variety of such services presents a need for an effective mechanism for metering and billing for consumption of such services. Such diverse features as text, audio files, video files, and photographs, lead to variation in quantities of data consumption by different customers employing the same or similar Internet connection mechanisms. It is therefore desirable to keep track of the level of service consumed by individual customers.

One mechanism for tracking such usage is Internet Usage Manager (IUM). IUM is a network use mediation mechanism that gathers usage information from network devices such as routers, ATM switches, Web servers, mail servers, VOIP (Voice over Internet Protocol) and wireless gateways and filters and combines that information based on customer site needs, and then makes that information easily available to any application through file based or programmatic (API) means. Applications which may be built on top of IUM include billing, capacity planning, fraud detection, and marketing analysis.

Simple Network Management Protocol (SNMP) is a set of widely used standards for multi-vendor, interoperable network management. The SNMP protocol is commonly used for network managers to manage and exchange information with their agents. Network management information for an agent is stored in a database called Management Information Base (MIB) that consists of a set of objects. All managed objects are arranged in a hierarchical or tree structure. Each object is generally associated with a unique identifier and generally consists of a sequence of integers such as, for instance, 1.3.1.6.1.2.1.1.3 (representing iso.org.dod.intemet.mgmt.mib2.system.sysuptime). This unique identification is called Object Identifier (OID). In the foregoing, “iso” stands for International Organizations for Standards; “org” stands for “organization”; “dod” stands for Department of Defense”; “mgmt” stands for management; “mib2” stands for management information base 2; and “sysuptime” stands for “system up time” which is the elapsed time to any given moment from the point in time where the system was last initialized.

Information is generally exchanged between a manager and an agent in the form of an SNMP message which usually specifies an SNMP-Get or SNMP-Set operation. A network manager may monitor an agent by retrieving the values of some objects in the agent's MIB using an SNMP-Get or SNMP-GetNext operation and may control that agent by modifying those values though an SNMP-Set operation.

An SNMP-Get operation is generally a command to retrieve information concerning an object or row entry in a MIB table. An SNMP Set operation is generally a command which assigns values to an object or row entry in a MIB table. An SNMP GetNext operation is generally a command to retrieve information regarding a row in a MIB table which immediately succeeds a row identified by a particular OID.

Generally, SNMP operations involve access to an object instance in a MIB. To facilitate multiple-object exchanges, SNMP messages generally include a “variable bindings” field. This field generally consists of a sequence of references of object instances, together with the values of those objects. When a MIB object is a table containing multiple rows, an SNMP-GetNext operation is usually used to scan the table in order to find the value of the object instance that occurs next in the table according to the previously referenced sequence of references.

“Remote Monitor” (RMON) is an enhanced form of SNMP protocol. RMON generally defines an algorithm and database for managing remote local area networks (LANs). Generally, a system or network device that implements the RMON specification is called an RMON probe. The RMON probe is generally able to capture network traffic information, reading and/or writing its local RMON MIB, and communicating with network managers via SNMP protocol. The RMON probe is generally able to capture information in the physical layer of the seven layer OSI (Open Systems Interconnect) network protocol stack.

RMON2 represents an upgrade to RMON that provides analysis up to the application layer of the OSI network protocol stack. In addition, RMON2 generally improves efficiency of communications between managers and their probes by providing a special “MIB trick” in order to retrieve, from a MIB table, only the rows that have experienced a change in value of a row entry, within such MIB table, through the use of a new indexing object called “time filter.” Using the time filter mechanism, a management station generally retrieves only rows whose entries have changed since a specific point in time by setting the time filter component to such specific point in time in an SNMP-GetNext operation.

While the use of RMON 2 MIB tables generally condenses information describing network usage activity, data consumption information is still usually presented in a manner which cumulates all such data consumption occurring since a fixed point in time in the history of such customer's connection to the network. Accordingly, such information may not be readily usable for billing purposes without further processing of the retrieved data.

Accordingly, it is a problem in the art that existing internet usage monitoring acquires data quantifying data consumption over extensive time periods.

It is a further problem in the art that data elicited by existing internet usage monitoring generally requires further processing to become usable for billing network customers.

### SUMMARY OF THE INVENTION

The present invention is directed to a system and method for metering Internet usage, including monitoring Internet usage by a customer, logging data processing resource consumption by the monitored Internet usage, and determining a quantity of data processing resource consumption logged within a defined time period by the customer. It will be appreciated that network usage by more than one customer at a time may be logged and tabulated by the system and method of the present invention.

### BRIEF DESCRIPTION OF THE DRAWING

FIG. 1 is a block diagram illustrating the use of Internet usage metering information for billing purposes according to a preferred embodiment of the present invention;

FIG. 2 depicts a selection of operational components of an Internet Usage Manager in communication with a probe according to a preferred embodiment of the present invention;

FIG. 3 is a block diagram which depicts the creation of a hash table for measuring customer usage of a network according to a preferred embodiment of the present invention;

FIG. 4 is a table of exemplary entries corresponding to a first polling result of Internet usage activity according to a preferred embodiment of the present invention;

FIG. 5 is a table of exemplary entries corresponding to a second polling result of Internet usage activity according to a preferred embodiment of the present invention;

FIG. 6 is a table of exemplary entries corresponding to a third polling result of Internet usage activity according to a preferred embodiment of the present invention;

FIG. 7 depicts exemplary tabulated records of Internet usage activity determined according to a preferred embodiment of the present invention; and

FIG. 8 depicts computer apparatus adaptable for use with a preferred embodiment of the present invention.

### DETAILED DESCRIPTION

The present invention is directed to a system and method for extracting information quantifying service consumption occurring between at least two sites on a network for ready calculation of billing data. Generally, the pertinent service consumption measurement concerns service consumed by a customer in communication with a network.

Whereas prior art approaches indicated service consumption in terms of total quantities, the inventive approach preferably isolates information identifying data processing resource consumption occurring within a defined time window. Preferably, this isolated information is used to provided detailed information suitable for use in billing customers for use of a network such as the Internet.

Herein, the terms “network usage,” “Internet usage,” “service consumption,” and “data processing resource consumption” generally correspond to a quantity of service, such as data acquisition, provided to a customer over a network such as the Internet. Service consumption may include, but is not limited to, acquisition of data, over a network, in the form of text data, image data, audio data, and/or video data. Service consumption may also correspond to an amount of reserved bandwidth, the directness and/or speed of one or more communication paths, the quality of service of a customer's Internet connection, a number of messages transmitted and/or received, a measure of processing effort expended by a computer on a node remote from a particular user site on a network, such as for searching purposes, a number of data records searched through, or a combination of any of the foregoing. As discussed in greater detail elsewhere herein, it is generally desirable for billing purposes to identify a quantity or measure of such data processing resource consumption occurring within a defined time window of access to a network by a particular user or customer.

Herein the term “site” generally corresponds to a node, in communication with a network, having a distinct IP (Internet Protocol) address, and the term “absolute time” generally corresponds to a quantity such as the time of day or other time measurement referring back to a substantially universal chronological reference point.

In a preferred embodiment, the present invention provides an ability to calculate variations in data consumption, or other service consumption, between successive polling cycles for billing purposes. While RMON2 is able to return data table entries which have changed since a specific time instance, or point in time, generally, no indication is provided regarding the amount by which such entries have changed, as the values provided are absolute values of data consumed. The foregoing is true because table entries are generally populated for the first time when the RMON2 probe is restarted.

However, since the second element of a RMON2 MIB table row index, the time filter element, preferably provides a time stamp associated with data consumption information since a specific time instance, incremental data consumption information can be obtained by calculating the difference between two instances of the same MIB table row entry at two different points in time.

In a preferred embodiment, the IUM RMON2 Encapsulator preferably accomplishes this by stripping out the time filter component of a MIB table row index and using the remaining row index as a key to an internal hash table entry. Preferably, data consumption information is stored as the value for an entry that can be later accessed using that key. In the next polling cycle that retrieves information from the MIB table, data consumption information for the preceding period may be obtained by using a table row index, which lacks a time filter component, as a key to the hash table.

In a preferred embodiment, cumulative data consumption information for the last time period, is obtained from the hash table. Preferably, a difference between cumulative data consumption values gathered in successive polling operations is then calculated to calculate the amount of data consumed between two such successive polling operations. The cumulative data consumption value for the current polling cycle is then preferably stored in the hash table to enable calculation of incremental data consumption information upon completion of succeeding polling cycle.

In a preferred embodiment, activity for which customers may be billed includes, but is not limited to, a quantity of data transmitted from a network to the customer, a quantity of data transmitted from a customer to a network, a quantify of data accessed or searched through during an Internet session, a measure of processing activity undertaken in response to a customer request by a computing node coupled to a network accessed by the customer, or a combination of any of the foregoing.

In a preferred embodiment, RMON 2 is a technology standard operating in conjunction with SNMP and operates to monitor network activity. One component of IUM, the RMON 2 encapsulator, preferably communicates with RMON 2 probes on a network once for each polling cycle (the duration of which may be established in advance), and acquires the MIB tables associated with each such RMON 2 probe. The RMON 2 probe preferably monitors traffic and populates RMON 2 MIB tables with traffic information collected during such monitoring activity. These RMON 2 MIB tables generally have objects which include IP (Internet Protocol) address, protocol source and definition, and time filter information that can be used to retrieve information recorded over a defined time window.

In a preferred embodiment, the RMON 2 probe monitors traffic and completes MIB table entries. Generally, each object in a MIB table is uniquely associated with an object identifier (OID). Preferably, when an RMON 2 encapsulator is configured, the IP address of the probe is specified along with the OID object being probed. Preferably, upon retrieving information about an object, this information may used as desired, such as, for instance, for generating usage and billing information. Thus, the present invention distinguishes over the prior art by enabling RMON 2 to determine variation in table entries, or objects, between successively instances of MIB tables.

Therefore, it is an advantage of a preferred embodiment of the present invention that network usage information may be gathered which is associated with a time period of known duration and having a start and end points defined in absolute time measurements.

It is a further advantage of a preferred embodiment of the present invention that the gathered network usage information may be used to readily generate billing information.

It is a still further advantage of a preferred embodiment of the present invention that billing information may be generated which accurately takes account of data processing resources consumed by a customer.

FIG. 1 illustrates the operation of a preferred embodiment of the present invention. Customer IP connection 300 is preferably connected to Internet 100 via service provider site 103. IUM (Internet Usage Manager) 200 preferably operates to monitor activity occurring between customer IP connection 300 (and, optionally, other such connections, such as customer IP connection N 300-N) and Internet 100, or other network, to generate Internet usage metering information 101 which in turn may be beneficially employed to generate billing information 102. In addition to billing information 102, IUM 200 may also be used to beneficially provide capacity planning information, fraud detection information, and/or marketing analysis information.

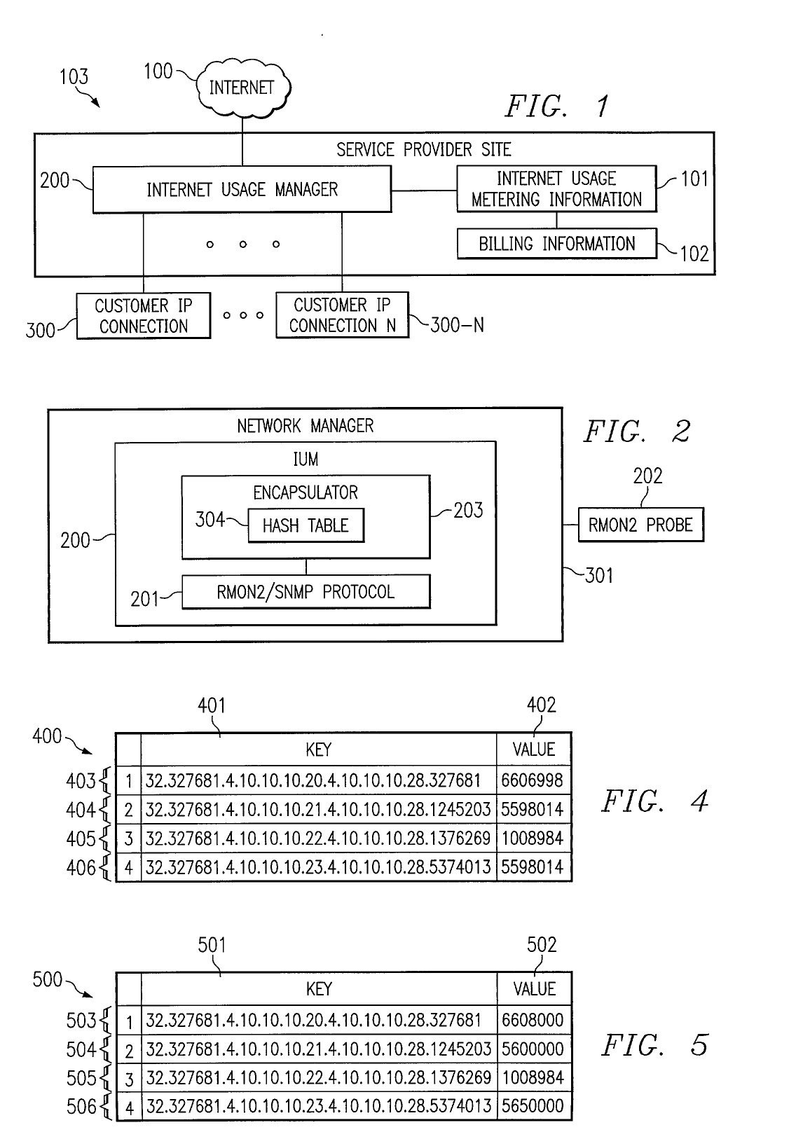

Turning to FIG. 2, it may be seen that IUM 200 may include, but is not limited to the functional elements of: RMON2/SNMP protocol 201 and RMON2 encapsulator 203. It will be appreciated that RMON2, or “Remote Monitor 2,” is but one protocol which may be employed in the inventive monitoring scheme and for the activities of encapsulator 203 while in communication with RMON2 probe 202. It will be appreciated that other protocols may be employed in conjunction with the present invention.

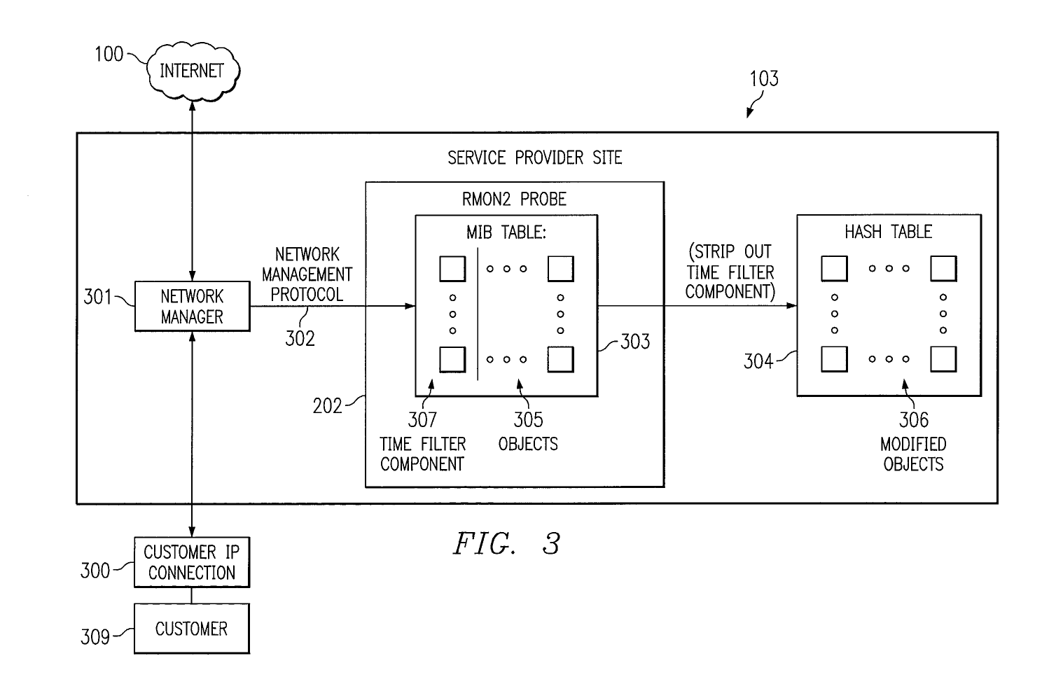

In a preferred embodiment, hash table 304, which is discussed in greater detail in connection with FIG. 3, is included within encapsulator 203, which, in turn, is included within IUM 200. IUM 200 performs a subset of the activities of network manager 301 which is discussed in greater detail in connection with FIG. 3. In addition to the operation of IUM 200, network manager 301 also preferably configures network devices, such as RMON2 probe 202.

In a preferred embodiment, IUM 200 retrieves data for usage metering via the transmission of appropriate commands, such as, for example, the SNMP “GetNext table-walk” command. Preferably, The IUM 200 entity that does the retrieving is RMON2 Encapsulator 203. When employing IUM 200, a user preferably configures RMON2 Encapsulator 203 by specifying the RMON2 probe's IP address, which RMON2 MIB objects to query (by specifying the objects' OIDs), how often to poll RMON2 probe 202, and other SNMP settings such as community and port number.

In a preferred embodiment, when polling is initiated, RMON2 Encapsulator 203 performs a query on the specified RMON2 probe 202 by issuing a series of SNMP-GetNext operations in a loop with the initial time filter index value of the “variable bindings” set to 0. The time filter is usually the second index component of the variable bindings indexes. The returned results generally include table entries whose values have changed since the immediately preceding polling cycle. These returned results are then preferably saved in an internal hash table. Preferably, the current sysUpTime value of the RMON2 probe is also saved for the next polling cycle. Generally, the last saved value of sysUpTime is used as the time filter value so that subsequent “table walks” will return only those rows that have changed since the last polling cycle. Generally, “table walks” are successive SNMP “get next” operations to retrieve all entries in a MIB table.

Herein, the “sysUpTime” value generally corresponds to a “system up time” value, meaning a measure of a total amount of time that the current system has been operating. This value may be measured in days, weeks, months or years, and generally far exceeds the length of any particular Internet session.

Reference is now made to FIG. 3. In a preferred embodiment, rows returned from polling MIB table 303 of RMON2 probe 202 are stored in hash table 304, wherein the row indexes serve as the keys to this table. Since RMON2 table row indexes contain time filter component 307, which varies from one polling cycle to the next, these indexes are then preferably further manipulated to strip out time filter component 307 so that the same row from different polling cycles can be attributed back to the same row in a hash table 304. This approach may be beneficially employed to calculate variations in table entries from one polling cycle to the next.

With further reference to FIG. 3, communication between customer IP connection 300 and Internet 100 is preferably monitored by Network Manager 301 in order to perform Internet usage metering for customer IP connection 300. Preferably a suitable network management protocol 302 is employed for interaction between network manager 301 and MIB table 303. Network management protocol 302 may be any suitable protocol, including but not limited to: SNMP, RMON, or RMON2. IUM 200 (FIG. 2) functionality is generally a subset of the operations of network manager 301. Network manager 301 functionality is preferably implemented within service provider site 103. However, additionally or alternatively, usage metering could be implemented at a site which includes customer IP connection 300. Preferably, MIB table 303 is a component of RMON2 probe 202, as shown in FIG. 3.

It will be appreciated that the present invention may be practiced with any number of customers, a plurality of different network managers, optionally employing a variety of different network management protocols. Moreover, a plurality of different networks may be in communication with one or more customers, and all such variations are included within the scope of the present invention.

In a preferred embodiment, network manager 301 configures RMON2 probe 202 to populate its local MIB table 303 with information intended for consumption by network manager 301. Objects 305 of MIB table 303 preferably include entries quantifying a measure of Internet service used over customer IP connection 300 as of a particular point in time, which point in time is indicated by time filter component 307. Generally, the quantities of Internet usage included in objects 305 are accumulated totals which count all usage beginning from a point in the history of interaction between customer IP connection 300 and Internet 100, and concluding at the point in time at which data in MIB table 305 is polled. Generally, the referenced point in the history of interaction between customer IP connection 300 and Internet 100 is substantially far removed from the point in time at which polling occurs. Generally, successive instances of MIB table 303 contain progressively greater accumulated totals of Internet 100 usage since the values are generally not reset. Customer 309 is shown accessing customer IP connection 300. It will be appreciated that a plurality of different customers could be connected to the Internet over IP connection 300, although generally only one customer may be so connected at one time. However, a plurality of different customers 309 could be connected in succession to the same IP connection 300.

When a customer is connected to a service provider, an IP connection having a unique IP address is generally provided to such customer. Thereafter, MIB table entries are generated which entries are generally cumulative over a time period beginning at a point in time when the RMON2 probe was turned on. Thus, such entries generally do not isolate the activity associated with one Internet session or one customer.

When a first customer disconnects from a particular customer IP connection, such as customer IP connection 300, the same IP address could end up being used by a different customer who later logs on to the same IP connection. However, the table entry values are generally not reset when a later user or customer gets connected to an IP address previously used by another customer. Thus, the table entry values will generally be supplemented by an amount reflecting the usage of such later user. Thus, when this later user's Internet session ends, the table entry values will generally represent quantities which are cumulative over a plurality of different Internet sessions. For this reason, it is desirable to extract from such table entries, Internet usage data reflecting changes in the cumulative usage measurements so as to isolate a measure of Internet usage associated with a single Internet session.

In a preferred embodiment, MIB tables, such as MIB table 303, are part of RMON2 probe 202 and are the source of information for IUM's RMON2 encapsulator 203 (FIG. 2). Preferably, RMON2 probe 202 monitors Internet 100 usage and populates its local MIB tables. IUM's RMON2 encapsulator 203 preferably communicates with RMON2 probe 202 via SNMP-“get next” commands to retrieve information from the RMON 2 probe's MIB tables. RMON2 encapsulator 203 then preferably strips time filter components out of the MIB table row indexes and stores these removed indexes as keys to its own internal hash table. RMON2 encapsulator 203 then preferably stores the MIB table row indexes as values in its hash table, which hash table is preserved for further processing. In addition to the time filter components, the MIB row indexes preferably include information such as source and destination IP addresses as well as protocol employed for communication between RMON encapsulator 203 and RMON2 probe 202.

In a preferred embodiment, it is desirable to extract information from successive instances of MIB table 303 in order to calculate changes in the measures of Internet usage over customer IP connection 300 over a defined time period. Such variations in the accumulated totals of Internet 100 usage in successive MIB table instances preferably represent the consumption of Internet usage over customer IP connection 300 in the time span between the polling cycles, thereby generating the successive instances of MIB tables 303. Similarly, the difference between accumulated totals of Internet 100 usage activity found in successively obtained MIB tables 303 may be calculated to determine the network usage occurring within a time period of known duration and having known start and end times.

For example, suppose that a first MIB table 303 instance includes an entry such as:

| Time of day: | Total consumed data: |
|---|---|
| 8:00 p.m.; | 101,000 Megabytes. |

And, suppose that a second MIB table 303 instance includes an entry such as:

| Time of day: | Total consumed data: |
|---|---|
| 9:00 p.m.; | 102,500 Megabytes. |

Calculating the difference between the absolute time values and byte quantities yields:

| Time Span: | Data Consumed: |
|---|---|
| 60 minutes; | 1,500 Megabytes. |

In the above example, the time period concerned is fully defined as starting at 8:00 p.m. and lasting one hour. The data consumed in between the two polling cycles, and in between the two MIB table entry instances, is shown to be 1,500 megabytes. The information in the last table above is preferably readily convertible into billing information. Moreover, such billing information may be readily itemized because of the available timing information. Thus, a bill for the service indicated in the last table above could read as follows:

| Cost: | Data Consumed: | Start time: | End Time: | Date |
|---|---|---|---|---|
| $15.00; | 1,500 Megabytes; | 8:00 p.m.; | 9:00 p.m.; | Mar. 1, 2001. |

In a preferred embodiment, modified Internet usage data is stored in hash table 304. The time filter components are preferably stripped out of the table row index of objects 305 and used as the keys to the internal hash table entries. Preferably, time differences between successive polling cycles are calculated and included within modified objects 306 within hash table 304. Modified objects 306 preferably include data representing usage activity within defined time periods. The “modification” of objects 306 generally refers to the removal of time filter components therefrom.

FIG. 4 is a table of exemplary entries corresponding to a first polling result of Internet usage activity according to a preferred embodiment of the present invention. An example is considered in which the inventive mechanism retrieves and processes MIB data using a polling interval of one minute.

The example begins with the date being Jan. 01, 2001, and the time 12:00 am. The current probe's “system up time” is 2,970,720,450 milliseconds (not shown). Four rows are returned from queries, which may be SNMP “getnext” operations, which rows are shown numbered 1 through 4, in FIG. 4, having reference numerals 403-406, respectively. The recovered entries are preferably stored in internal hash table 400. The time filter component is preferably removed from the row indexes. The removed time filter table row index is preferably saved as a key to hash table 400. This row index generally has encoded within it, additional information, such as, source IP (Internet Protocol) address, destination IP address, protocols, and port numbers.

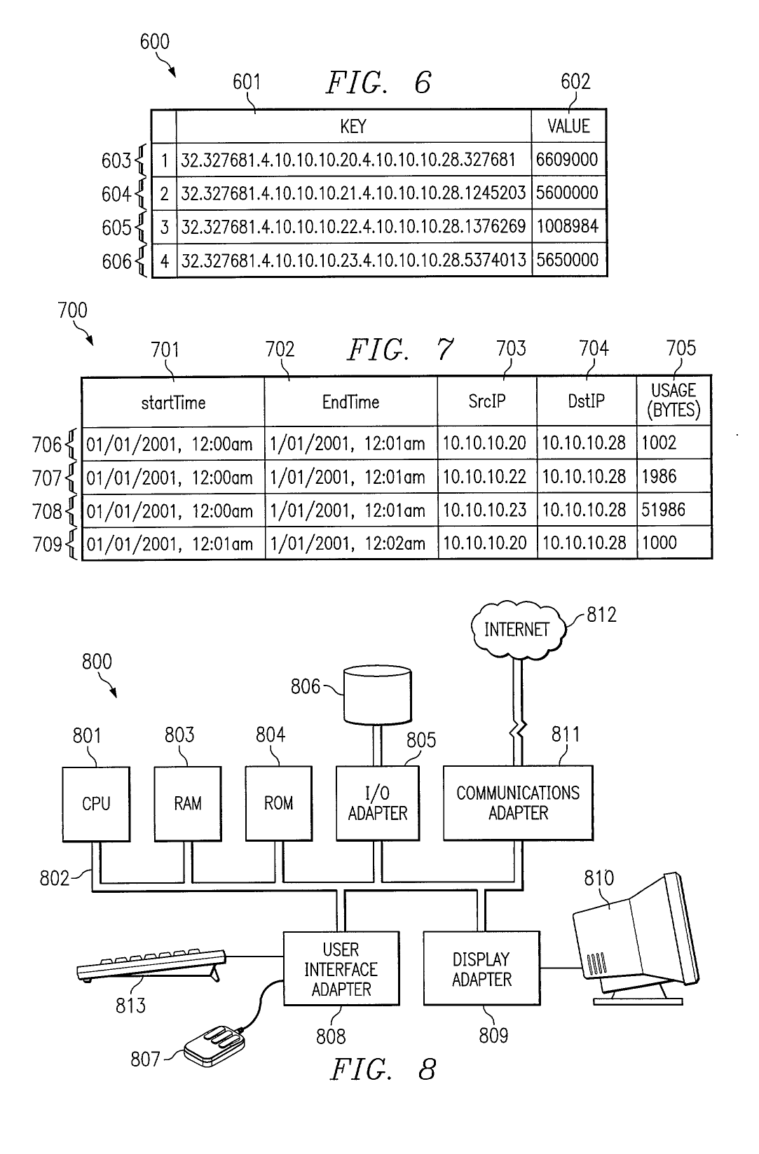

In a preferred embodiment, value column 402 preferably contains quantities of bytes transmitted for the IP (Internet Protocol) address listed on the same row. Key column 401 preferably includes entries identifying specific customers interacting with a network, such as the Internet, by the IP address of such customers. Key columns 501 and 601, in FIGS. 5 and 6, respectively, preferably also include information identifying specific customers.

Continuing with the example and turning to the table 500 of FIG. 5, the time is now 12:01 am (not shown). The system up time, or time filter value, is now 2,970,780,450 milliseconds (not shown), which is 60,000 milliseconds, or one minute, later than the polling operation whose results are shown in FIG. 4. It may be seen that value entry 502 has changed only for rows 1 503, 2 504, and 4 506, while the entry for row 3 505 is unchanged. As with key column 401 in FIG. 4, column 501 preferably includes entries identifying specific customers interacting with a network.

Continuing with the example, a third polling operation is then conducted at a real clock time of 12:02 am, or 60,000 milliseconds after the second polling operation whose results are displayed in FIG. 6. A review of table 600 in FIG. 6 indicates that value 602 has only changed for row 1 603. Specifically, the entry at the intersection of value column 602 and row 1 603 has changed from 6,608,000 to 6,609,000, indicating an increase of 1000, or a consumption of 1000 bytes by a customer having the IP address indicated in the “key” field 601 for row 1 603. The entries in value column 602 for rows 604-606 remain unchanged from the entries in rows 504-506, respectively, of column 502 in FIG. 5. The entries in value columns 402, 502, and 602 of FIGS. 4, 5, and 6, respectively, generally correspond to modified objects 306 discussed in connection with FIG. 3.

Continuing with the example, table 700 of FIG. 7 illustrates usage records based on information gathered in three polling cycles according to a preferred embodiment of the present invention. Data for the table of FIG. 7 is shown separated into column “Start time” 701, column “end time” 702, source IP address 703, destination IP address 704, and usage, expressed in bytes 705. Each of rows 706-709 are associated with a quantity of data usage or consumption, over a period of time having a specified duration and specified start and end times identified in absolute time, occurring between a source and destination devices, both such devices being identified by IP address.

Referring to FIG. 7 and row 706 in particular, it may be seen that on Jan. 1, 2001, between 12:00 and 12:01 am, 1002 bytes were used, or communicated, between source IP address 10.10.10.20 and destination IP address 10.10.10.28. It may also be seen, referring to row 709, that data usage, between the same two locations, and between 12:01 am and 12:02 am, was 1000 bytes. Similar observations may be made with respect to data included within rows 707 and 708.

In a preferred embodiment, the data included in FIG. 7 is readily usable for billing purposes in view of the precise identification of the parties to a communication session over a network, the identification of specific start times 701 and end times 702, and the clear presentation of the data consumed during such communication session (Usage column 705).

Preferably, the inventive mechanism extracts the useful data entered in FIG. 7 from data presented in FIGS. 4-6. For example, it may be seen that the data for row 706 in FIG. 7 may be extracted from row 403 in FIG. 4 and row 503 in FIG. 5. The time filter values associated FIGS. 4 and 5 have previously been identified as being 12:00 am 12:01 am respectively. A review of the address information in row 403 of FIG. 4 and row 503 of FIG. 5 indicates that the same IP addresses are concerned therein as in row 706 of FIG. 7. And, finally, calculation of the difference between the “value” entered in row 503 of FIG. 5 and row 403 of FIG. 4 yields 6,608,000−6,606,098=1002, which is entered in the “usage” 705 portion of row 706.

FIG. 8 illustrates computer system 800 adaptable for use with a preferred embodiment of the present invention. Central processing unit (CPU) 801 is coupled to system bus 802. CPU 801 may be any general purpose CPU, such as a Hewlett Packard PA-8200. However, the present invention is not restricted by the architecture of CPU 801 as long as CPU 801 supports the inventive operations as described herein. Bus 802 is coupled to random access memory (RAM) 803, which may be SRAM, DRAM, or SDRAM. ROM 804 is also coupled to Bus 802, which may be PROM, EPROM, or EEPROM. RAM 803 and ROM 804 hold user and system data and programs as is well known in the art.

Bus 802 is also preferably coupled to input/output (I/O) adapter 805, communications adapter card 811, user interface adapter 808, and display adapter 809. I/O adapter 805 connects to storage devices 806, such as one or more of a hard drive, CD drive, floppy disk drive, tape drive, to the computer system. Communications adapter 811 is adapted to couple computer system 800 to Network or Internet 812, which may be one or more of a local area network (LAN), wide-area network (WAN), Ethernet or Internet network. User interface adapter 808 couples user input devices, such as keyboard 813 and pointing device 807, to computer system 800. Display adapter 809 is driven by CPU 801 to control the display on display device 810.

What is claimed is:

1. A method for metering Internet usage comprising the steps of:
monitoring Internet usage by a customer;
logging data processing resource consumption information occurring during said monitored Internet usage; and
determining a quantity of data processing resource consumption logged within a defined time period by said customer.

2. The method of claim 1 wherein the step of monitoring comprises the steps of:
polling a connection between said customer and the internet;
acquiring data reflecting total processing resource consumption by said customer; and
associating said acquired data processing resource consumption data with a measure of absolute time.

3. The method of claim 2 wherein the step of logging comprises the step of:
storing said acquired data processing resource consumption data and said associated absolute time in a first table.

4. The method of claim 3 wherein the determining step comprises the steps of:
calculating a difference in data processing resource consumption between successive polling steps; and
calculating a difference in absolute time between said successive polling steps.

5. The method of claim 4 further comprising the step of:
storing said calculated differences in data processing resource consumption and absolute time between said successive polling steps in a second table.

6. The method of claim 1 wherein said step of determining a quantity of data processing resource consumption comprises the step of:
determining a quantity of data received by said customer.

7. The method of claim 1 wherein said step of determining a quantity of data processing resource consumption comprises the step of:
determining a quantity of data transmitted by said customer.

8. The method of claim 1 wherein said step of determining a quantity of data processing resource consumption comprises the step of:
determining a number of records searched within said defined time period.

9. The method of claim 1 wherein said step of determining a quantity of data processing resource consumption comprises the step of:
determining a number of messages transmitted within said defined time period.

10. A system for metering network usage by at least one customer comprising:
a network manager for monitoring interaction with said network of said at least one customer;
an initial network usage metering table for storing network usage data acquired during individual polling cycles; and
a modified network usage metering table for storing network service consumption associated with specific time periods and derived from said data acquired during said individual polling cycles.

11. The system of claim 10 wherein said modified network usage metering table comprises:
entries representing network addresses of sources of data transmission occurring during said specific time periods.

12. The system of claim 10 wherein said modified network usage metering table comprises:
entries representing network addresses of destinations of data transmissions occurring during said specific time periods.

13. The system of claim 10 wherein said modified network usage metering table comprises:
entries representing a measure of network resources consumed by said at least one customer.

14. The system of claim 13 wherein said measure of network resources comprises:
a quantity of data received by said at least one customer.

15. The system of claim 13 wherein said measure of network resources consumed comprises:
a measure of processing effort expended at a node on said network in response to a request from said at least one customer.

16. The system of claim 13 wherein said measure of network resources consumed comprises:
a number of messages transmitted by said at least one customer.

17. The system of claim 10 wherein said modified network usage metering table comprises:
start times of said specific time periods.

18. A computer program product having a computer readable medium having computer program logic recorded thereon for metering Internet usage by a user site in communication with the Internet, the computer program product comprising:
code for monitoring said Internet usage by said user site;
code for polling a status of data processing resource consumption by said monitored Internet usage;
code for tabulating said polled data processing resource consumption status; and
code for extracting information, from said tabulated data, representing data processing resource consumption occurring within a defined time window.

19. The computer program product of claim 18 wherein said code for extracting comprises:
code for generating entries to a hash table representing differences in elapsed time and data processing resource consumption between successive polling operations.

20. The computer program product of claim 18 wherein said information representing data processing resource consumption comprises:
data reflecting a quantity of data received by said user site within said defined time window.
